(19) United States
(12) Patent Application Publication
(10) Pub. No.: US 2021/0009313 A1
(43) Pub. Date: Jan. 14, 2021

(54) Tackle Bag with Tray

(71) Applicant: Thousand Oaks Corp., Irwindale, CA (US)

(72) Inventor: Roger Tan, Chino, CA (US)

(21) Appl. No.: 16/925,235

(22) Filed: Jul. 9, 2020

Related U.S. Application Data
(63) Continuation-in-part of application No. 29/697,568, filed on Jul. 9, 2019, now Pat. No. D901882.
Application No. 29/697,568 is a continuation-in-part of application No. 29/697,572, filed on Jul. 9, 2019.
Application No. 29/697,572 is a continuation-in-part of application No. 29/697,578, filed on Jul. 10, 2019.
(60) Provisional application No. 62/872,243, filed on Jul. 9, 2019.
(60) Provisional application No. 62/872,249, filed on Jul. 10, 2019.
(60) Provisional application No. 62/872,247, filed on Jul. 10, 2019.

(51) Int. Cl. B65D 25/10; A01K 97/06

(52) U.S. Cl. CPC B65D 25/10; A01K 97/06

(57) ABSTRACT

A portable storage device having a having a tray. The portable device having a main storage compartment defined by a front wall, a rear wall, a first side wall, a second side wall, and a bottom wall, with each of said walls being of a cloth like material coupled together. The portable device further having a top portion that coupled to one or more of said walls and capable of covering an opening defined by the main storage compartment. The top portion configured to create a tray for use. The main storage compartment of the portable device can be sized and shaped to house at least one folding storage compartment. The portable device can also be included as part of a system. The system including a storage tray that is sized and configured to fit within the portable device.

### CROSS-REFERENCE TO RELATED APPLICATIONS

This application which claims the benefit of U.S. Provisional Application No. 62/872,243, filed Jul. 9, 2019, U.S. Provisional Application No. 62/872,249, filed Jul. 10, 2019, and U.S. Provisional Application No. 62/872,247, filed Jul. 10, 2019, is a continuation-in-part application of co-pending U.S. Design application No. 29/697,568, filed Jul. 9, 2019 entitled “Sling Bag,” co-pending U.S. Design application No. 29/697,572, filed Jul. 9, 2019 entitled “Tackle Binder with Hooks,” and co-pending U.S. Design application No. 29/697,578, filed Jul. 10, 2019 entitled “Sling Bag with Hooks,” the technical disclosures of all of which are hereby incorporated by reference in their entirety

### BACKGROUND

### Technical Field

The present disclosure relates to portable storage devices. More particularly, and not by way of limitation, the present disclosure is directed to a bag having a storage compartment with a fabric catch that limits the movement of a storage compartment cover.

### Background

This section is intended to provide a discussion of related aspects of the art that can be helpful to understanding the embodiments discussed in this disclosure. It is not intended that anything contained herein be an admission of what is or is not prior art, and accordingly, this section should be considered in that light.

Bags are a convenient way to carry large or small items. Bags can have handles so that they can be carried by hand, or straps that allow the bags to be carried on a user's body. For example, slings or backpacks have straps that allow the bag to be carried on a user's shoulders. Likewise, a fanny pack has a strap that allows the bag to be carried around a user's waist.

Bags can be specially configured for specialized use cases. For example, tackle boxes are designed to allow a user to carry tackle gear, food, and/or clothing.

### BRIEF SUMMARY

This summary provides a discussion of aspects of certain embodiments of the disclosure. It is not intended to limit the disclosure or any of the claimed subject matter. The summary provides some aspects but there are aspects and embodiments of the disclosure that are not discussed here.

The present disclosure is directed to portable storage device with a tray. The portable device can have a main storage compartment defined by a front wall, a rear wall, a first side wall, a second side wall, and a bottom wall, with each of said walls being of a cloth like material. The portable device may further have a top portion that is coupled to one or more of the said walls and capable of covering an opening defined by the main storage compartment, wherein the top portion has at least one securing mechanism to couple to a counterpart securing mechanism found on the outer side of the wall opposing the wall that the top portion is coupled to. The main storage compartment of the portable device can be sized and shaped to house at least one folding storage compartment having a front section, a first side section, a second side section, a rear section, a bottom section, and a top section, these sections may be coupled to the first and/or second side walls. When the top portion is released a catch prevents the top portion from traveling more than ninety degrees, and/or creates a ninety-degree angle with the main storage compartment to create a tray.

In another aspect, the present disclosure is directed to a storage system having at least one storage tray. The storage tray(s) having a top section, a bottom section, and a securing mechanism to removably coupled the top section and bottom section together. The storage system also includes a storage apparatus configured to carry the at least one storage tray within a main storage compartment that is defined by a front wall, a rear wall, a first side wall, a second side wall, and a bottom wall, with each of said walls being of a cloth like material. The storage apparatus can have a top portion that is coupled to one or more of the said walls and capable of covering an opening defined by the main storage compartment and that secured with at least one securing mechanism that couples to a counterpart securing mechanism found on the outer side of the wall opposing the wall that the top portion is coupled to. The main storage compartment of the portable device can be sized and shaped to house at least one folding storage compartment having a front section, a first side section, a second side section, a rear section, a bottom section, and a top section, these sections may be coupled to the first and/or second side walls. When the top portion is released a catch prevents the top portion from traveling more than ninety degrees, and/or creates a ninety-degree angle with the main storage compartment to create a tray.

In yet another aspect, the present disclosure is directed to a method of manufacture of a storage apparatus. The storage apparatus can be manufactured by cutting fabric like materials to create a front wall, rear wall, a first side wall, a second side wall, a bottom wall, and a removably coupled top of a main storage compartment. Additionally, there may be further cutting of fabric like materials to create a front folding section, a first side folding section, a second side folding section a rear folding section, and a bottom folding section of a foldable storage compartment. The cut pieces can then by sewn together to create the main storage compartment and the foldable storage compartment. A coupling through a stitching process of the main storage compartment and foldable storage compartment allows the first side folding section and the first side wall, the second side folding section and the second side wall, and the bottom section and bottom walls to be coupled to one another.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1A is an illustration of the exterior front of a sling bag in a side view.

FIG. 1B is an illustration of the exterior of a sling bag in a rear view.

FIG. 1C is an illustration of the interior view of a sling bag.

FIG. 1D is an illustration of the interior view of a sling bag.

FIG. 2A is an illustration of the exterior front of a sling bag in a side view.

FIG. 2B is an illustration of the exterior of a sling bag in a rear view.

FIG. 2C is an illustration of the interior view of a sling bag.

FIG. 2D is an illustration of the interior view of a sling bag.

FIG. 3 is an illustration of the interior view of a sling bag.

### DETAILED DESCRIPTION

An embodiment of the disclosure will now be described. Fishing equipment such as tackle boxes often have storage compartments which prevent fishermen from viewing any secured content. Since many tackle boxes are often used while fishermen are standing in water, the fishermen often must risk exposing at least one entire storage compartment's contents to water to simply see or access stored items. Most tackle boxes are designed to store bait trays within their sealed storage compartments. Although bait trays often are designed to allow fishermen to view stored contents while sealed, fishermen often lose all visibility to a bait tray's contents when the bait tray is stowed inside a sealed tackle box.

One of the additional downfalls of these devices is that often there is no manner or means for adjusting a tackle box's storage size. In many cases, tackle boxes are designed to hold a static number of bait trays. When a fisherman requires less bait trays than a tackle box is designed to store, fishermen often must choose to either use a smaller tackle box, underfill bait trays, and/or underfill the tackle box.

Another of the additional downfalls of these devices is that often there is no manner or means for creating a flat surface inside a tackle box. In many cases a fisherman must utilize external devices to create a flat surface while standing in water. Often these external devices are not secured to the fisherman's body and carry the risk of falling into water.

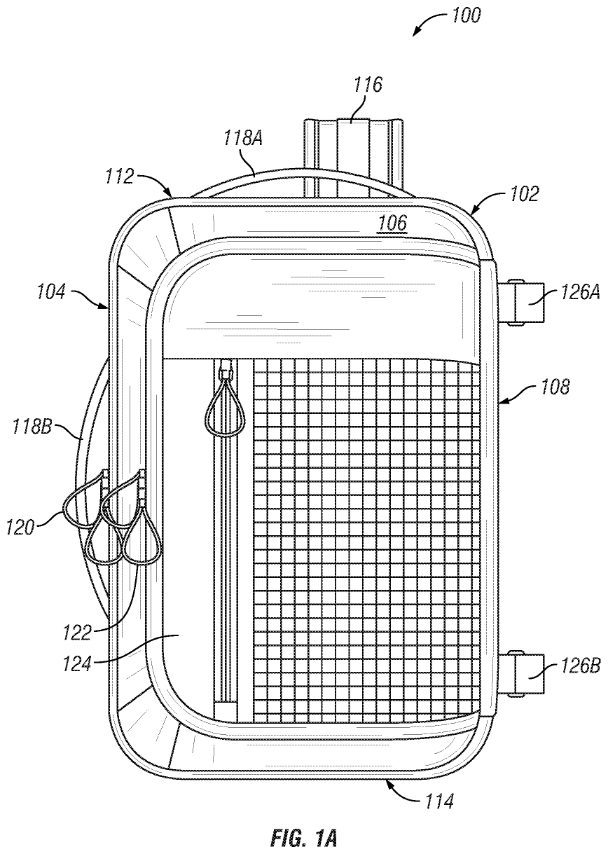

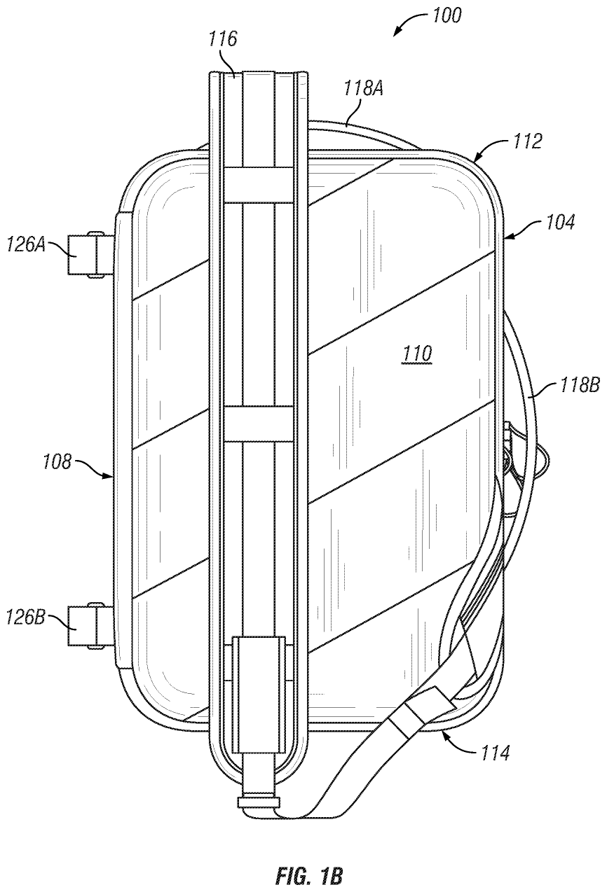

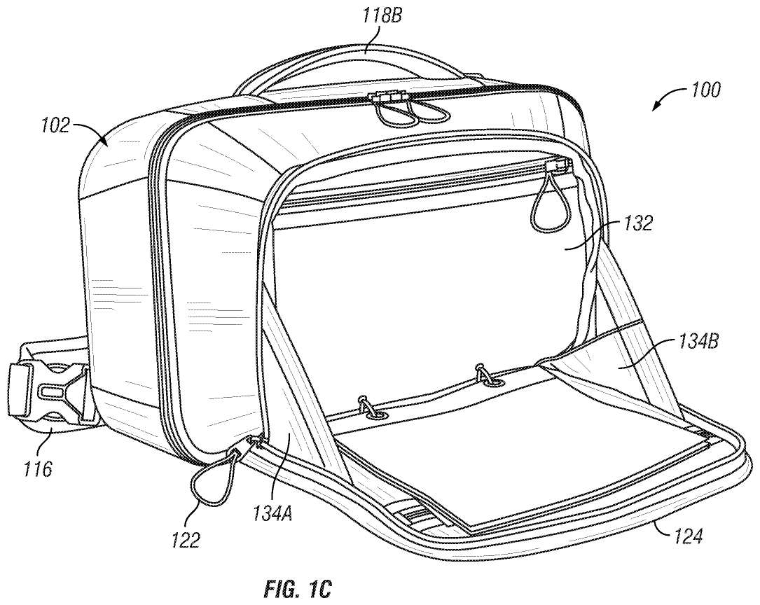

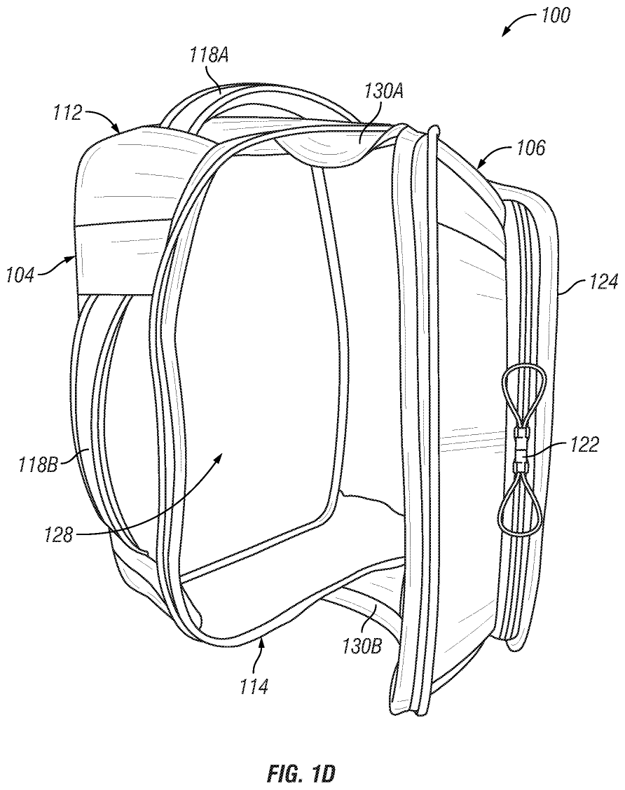

The novel aspects disclosed herein describe an apparatus, system, and method for addressing these challenges. FIGS. 1A and 1B are illustrations depicting external perspective views of a sling bag 100 in accordance with the present disclosure. FIGS. 1C and 1D are illustrations of internal cavities of the sling bag 100 from perspective views in accordance with the present disclosure. With reference to FIGS. 1A-1D, the sling bag 100 generally includes a body 102 defining a cavity therein, which is shown in more detail in FIG. 1D that follows. The body 102 is generally shown as having a set of rectangular sidewalls 104, 106, 108, and 110 separating one endwall 112 from an opposite endwall 114. For ease of reference, endwall 112 may also be referred to in the alternative as the top wall and the endwall 114 may also be referred to as the bottom wall. Likewise, sidewall 110 may be referred to as the back wall and sidewall 106 may be referred to as the front wall 106.

In one embodiment, one or more of the walls defining the body 102 of the sling bag 100 are formed from a pliable fabric so that the body 102 is easily deformable. In another embodiment, one or more of the walls defining the body 102 are rigid to resist deformation. For example, one or more of the walls can be formed from a rigid fabric, such as ballistic resistant fabric. Alternatively, one or more of the walls of the body 102 can include a rigid inner layer formed from a metallic or polymeric material and sandwiched between layers of fabric so that the one or more walls resist deformation.

The sling bag 100 includes a set of shoulder straps 116 attached to the body 102. As used herein, the term “set” means one or more. Accordingly, in one embodiment, the set of shoulder straps 116 can have a single shoulder strap to form a sling bag 100 or messenger bag as is known in the art, or the set of shoulder straps 116 can have two shoulder straps 116, which are commonly found on backpacks. In addition, the body 102 of sling bag 100 can include a set of handles attached thereto which provides a user with alternate means by which to carry the sling bag 100. In this non-limiting embodiment, the set of handles includes a first handle 118A attached to the endwall 112 and a second handle 118B attached to the sidewall 104.

The sling bag 100 includes a fastening device 120 that can be used to seal and unseal the cavity within the body 102. In this embodiment, the fastening device 120 is a zipper; however, in alternate embodiments any conventional fastening device may be implemented, including hook-and-loop fasteners, buttons, or straps.

The sling bag 100 includes a storage compartment 128 that is bounded on one side by the exterior of the front wall 106 and a foldable panel 124. In at least one example, the foldable panel 124 is fixedly attached to the body 102 along one side and releasably attached to the body 102 along the remaining three contiguous sides. Detaching the three releasably attached sides of the foldable panel 124 allows the foldable panel 124 to swing away from the front wall 106 of the body 102 with the fixedly attached side serving as a hinged side. As shown in FIG. 1D, a main fabric catch 130A, 130B releasable attaches the foldable panel 124 to the front wall 106. In this non-limiting embodiment, the fastener 122 is a zipper; however, other fastening devices may also be used instead. The main fabric catch 130A, 130B allows the foldable panel 124 to create a tray or folding tray for a user or fisherman to utilize without having to remove the sling bag 100 from their shoulder or body. The sling bag 100 may be configured with G-hooks and web couplers 126A, 126B, where the G-hooks and the web are coupled to one of the rectangular sidewalls 104, 106, 108, and/or 110. In at least one example, the G-hooks and web couplers 126A, 126B can be configured to secure an object, such as a fishing rod, for easier transportation. The main fabric catch 130A, 130B allows the front wall 106 to create a tray or folding tray for a user or fisherman to utilize without having to remove the sling bag 100 from their shoulder or body.

FIG. 1C depicts the interior of the storage compartment 132 with the foldable panel 124 separated from the front wall 106 of the sling bag 100. The storage compartment 132 is bounded on one side by the interior of the front wall 106. The front wall 106 is fixedly attached to the body 102 and/or foldable panel 124 along one side and releasably attached to the body 102 along the remaining three contiguous sides. Detaching the three releasably attached sides of the front wall 106 allows a portion of the front wall 106 to swing away from the front wall 106 of the body 102 and/or foldable panel 124 with the fixedly attached side serving as a hinged side. A panel fabric catch 134A, 134B releasable attaches the front wall 106 or portion of the front wall 106 to the foldable panel 124 or body 102. In this non-limiting embodiment, the fastener 122 is a zipper; however, other fastening devices may also be used instead. The panel fabric catch 134A, 134B allows the front wall 106 to create a tray or folding tray for a user or fisherman to utilize without having to remove the sling bag 100 from their shoulder or body. The storage compartment 132 may be configured to secure packets, pouches, or bags via a fastener(s), such as, but not limited to, ring binders, clasps, buttons, hook and loop or others known in the art.

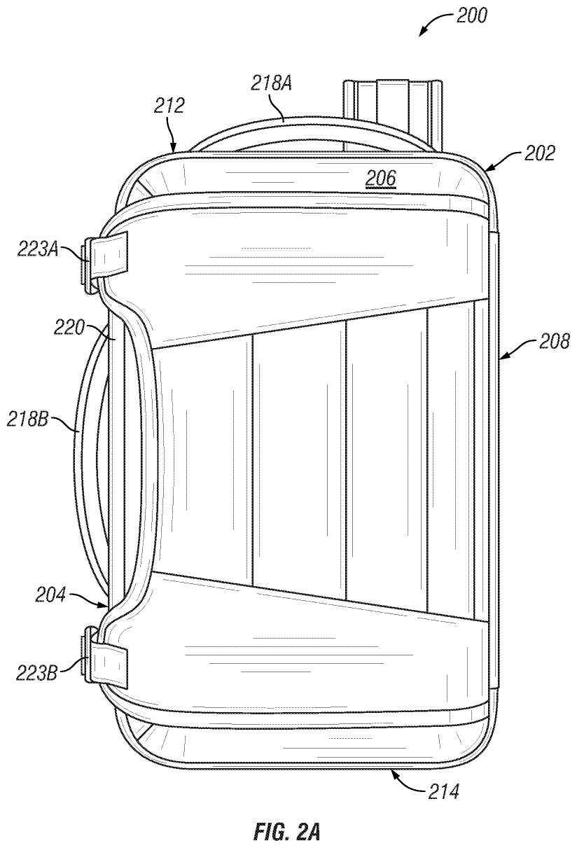

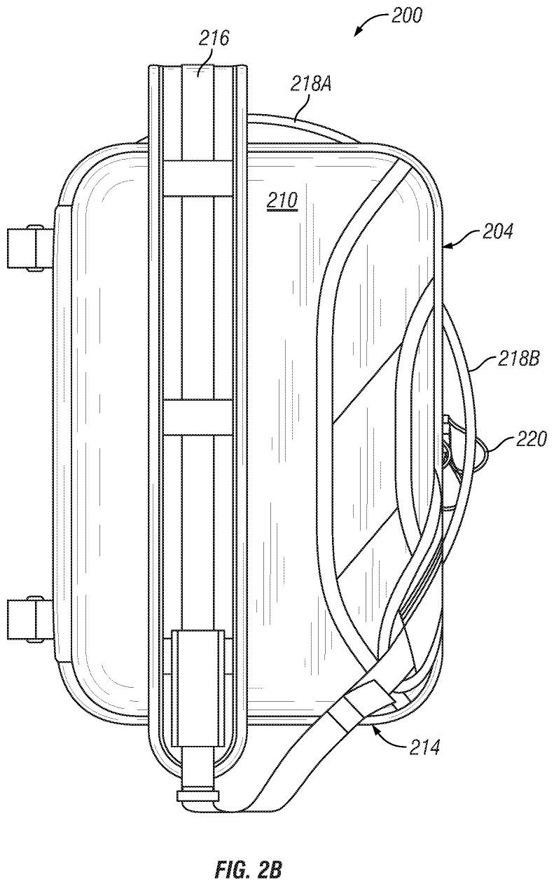

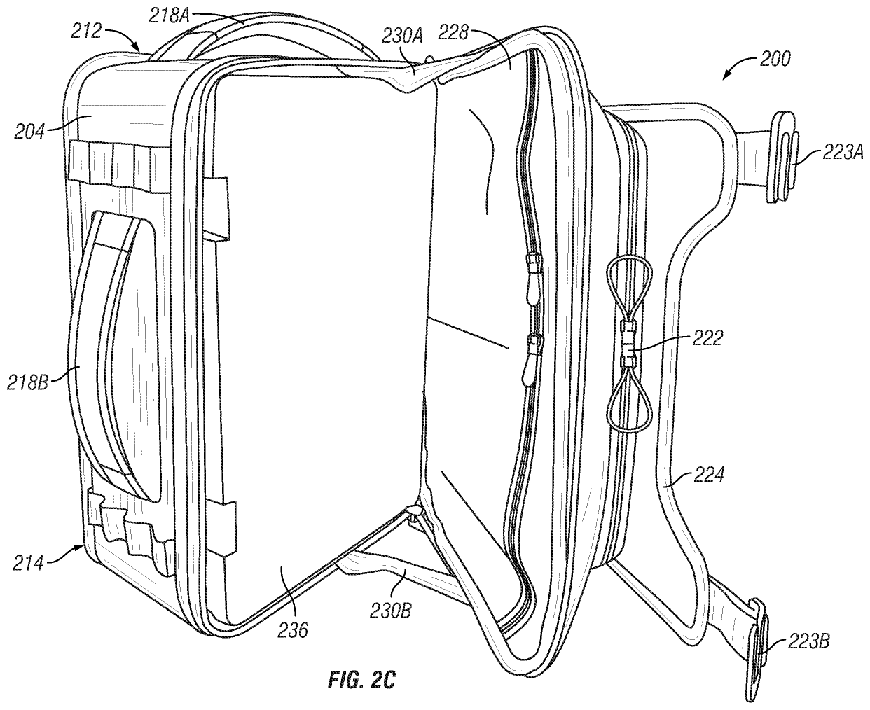

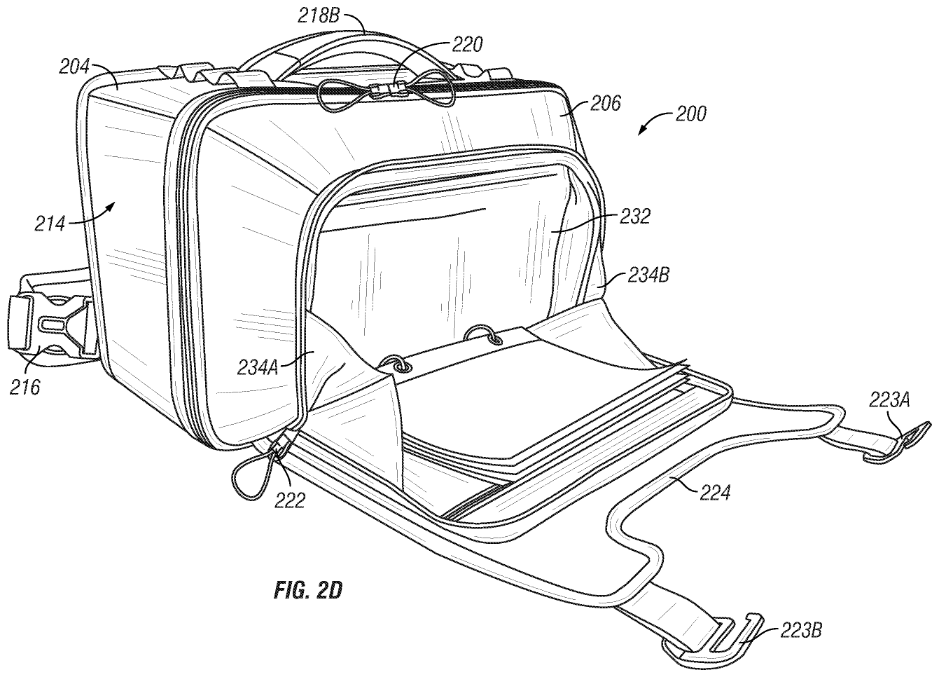

FIGS. 2A and 2B are illustrations depicting external perspective views of a sling bag 200 in accordance with the present disclosure. FIGS. 2C and 2D are illustrations of internal cavities of the sling bag 200 from perspective views in accordance with the present disclosure. With reference to FIGS. 2A, 2B, 2C, and 2D, the sling bag 200 generally includes a body 202 defining a cavity therein, which is shown in more detail in FIG. 2B that follows. The body 202 is generally shown as having a set of rectangular sidewalls 204, 206, 208, and 210 separating one endwall 212 from an opposite endwall 214. For ease of reference, endwall 212 may also be referred to in the alternative as the top wall and the endwall 214 may also be referred to as the bottom wall. Likewise, sidewall 210 may be referred to as the back wall and sidewall 206 may be referred to as the front wall.

In one embodiment, one or more of the walls defining the body 202 of the sling bag 200 are formed from a pliable fabric so that the body 202 is easily deformable. In another embodiment, one or more of the walls defining the body 202 are rigid to resist deformation. For example, one or more of the walls can be formed from a rigid fabric, such as ballistic resistant fabric. Alternatively, one or more of the walls of the body 202 can include a rigid inner layer formed from a metallic or polymeric material and sandwiched between layers of fabric so that the one or more walls resist deformation.

The sling bag 200 includes a set of shoulder straps 216 attached to the body 202. As used herein, the term “set” means one or more. Accordingly, in one embodiment, the set of shoulder straps 216 can have a single shoulder strap to form a sling bag 200 or messenger bag as is known in the art, or the set of shoulder straps 216 can have two shoulder straps, which are commonly found on backpacks. In addition, the body 202 of sling bag 200 can include a set of handles attached thereto which provides a user with alternate means by which to carry the sling bag 200. In this non-limiting embodiment, the set of handles includes a first handle 218A attached to the endwall 212 and a second handle 218B attached to the sidewall 204.

The sling bag 200 includes a fastening device 220 that can be used to seal and unseal the cavity within the body 202. In this embodiment, the fastening device 220 is a zipper; however, in alternate embodiments any conventional fastening device can be implemented, including hook-and-loop fasteners, buttons, or straps.

The sling bag 200 includes a storage compartment 228 that is bounded on one side by the exterior of the front wall 206 and a foldable panel 224. In at least one example, the foldable panel 224 is fixedly attached to the body 202 along one side and releasably attached to the body 202 along the opposite side. The foldable panel 224 can be released through the G-hooks and web couplers 223A, 223B, where the G-hooks are coupled to the foldable panel 224, and the web is coupled to the sidewall 204. The reverse is also possible in some examples. Detaching the releasably attached side of the foldable panel 224 allows the foldable panel 224 to swing away from the front wall of the body 202 with the fixedly attached side serving as a hinged side. As shown in FIG. 2C, a main fabric catch 230A, 230B releasably attaches the foldable panel 224 to the front wall. In this non-limiting embodiment, the fastener 222 is a zipper; however, other fastening devices can also be used instead. The main fabric catch 230A, 230B allows the foldable panel 224 to create a tray or folding tray for a user or fisherman to utilize without having to remove the sling bag from their shoulder or body. A tackle box 236 or tackle tray can be stored in the storage compartment 228. The main fabric catch 130A, 130B allows the front wall 106 to create a tray or folding tray for a user or fisherman to utilize without having to remove the sling bag 100 from their shoulder or body.

FIG. 2D depicts the interior of the storage compartment 232 with the foldable panel 224 separated from the front wall 206 of the sling bag 200. The storage compartment 232 is bounded on one side by the interior of the front wall 206. The front wall 206 is fixedly attached to the body 202 and/or foldable panel 224 along one side and releasably attached to the body 202 along the opposite side by a G-hook and web couplers 223A, 223B, where the G-hooks are coupled to the foldable panel 224, and the web is coupled to the sidewall 204. The reverse is also possible in some examples. Detaching the releasably attached side of the front wall 206 allows a portion of the front wall 206 to swing away from the front wall of the body 202 and/or foldable panel 224 with the fixedly attached side serving as a hinged side. A panel fabric catch 234A, 234B releasably attaches the front wall 206 or portion of the front wall 206 to the foldable panel 224 or body 202. In this non-limiting embodiment, the fastener is a zipper; however, other fastening devices may also be used instead. The panel fabric catch 234A, 234B allows the front wall 206 to create a tray or folding tray for a user or fisherman to utilize without having to remove the sling bag from their shoulder or body. The storage compartment 232 may be configured to secure packets, pouches, or bags via fasteners, such as, but not limited to, ring binders, clasps, buttons, hook and loop or others known in the art.

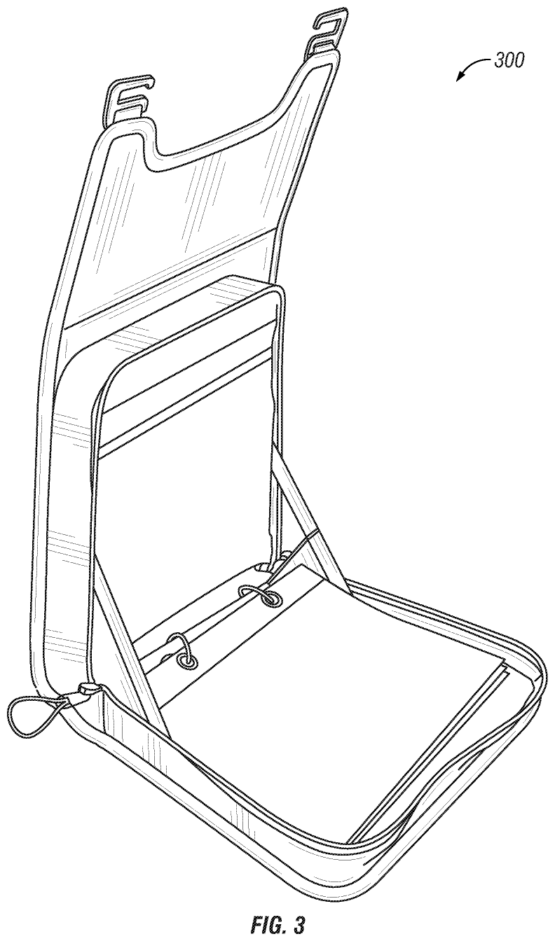

FIG. 3 provides a perspective view illustrations of an internal storage compartment. The sling bag 300 can include a single interior storage compartment, and have fabric catches like those shown in FIGS. 1A-1D. In at least one embodiment, the sling bag 300 can be manufactured in accordance with a single storage compartment. In other examples, the sling bag 300 can include a single interior storage compartment, and have fabric catches like those shown in FIGS. 2A-2D. In at least one embodiment, the sling bag 300 can be manufactured in accordance with a single storage compartment.

In at least one example, the sling bag 300 can be a storage device capable of being carried by a user (not illustrated) with at least one shoulder strap (as illustrated in FIGS. 1B and 2B, 116, 216). In some examples, the at least one strap may include two or more straps. The sling bag 300 can be configured to have a rectangular shape defined by a back wall, a front wall, a first side wall, a second side wall, a bottom wall, and/or a top wall. In at least one example, the back wall, front wall, first side wall, the second side, a bottom wall, and/or a top wall may have a rigid interior layer made of solid materials including, but not limited to, plastic, metal or other solid materials with exterior layers of supportive materials including, but not limited to, cloth, vinyl, canvas, or other similar materials. In at least one embodiment, the back wall, the front wall, the first side wall, the second side, the bottom wall, or the top wall can be constructed having both an interior and exterior composed of flexible or fabric like materials such a cloth, vinyl, canvas, or other similar materials. Fabric like materials can be cut to create in a pattern that defines and creates the back wall, front wall, first side wall, the second side, a bottom wall, or a top wall of the sling bag 300.

In at least one embodiment, the back wall, the front wall, the first side wall, and the second side wall may have an expandable storage compartment coupled to one or more of the walls. In at least one example, the expandable storage compartment can expand to create the expanded storage compartment. An expandable storage top connector may be used to enclose the expanded storage compartment. The expandable storage top connector can be adjustable using an expandable storage top fastener to allow for the storage a plurality of equipment and other items inside the expanded storage compartment. The expandable storage top fastener could include, but is not limited to, zippers, hook and loop fasteners, buttons, snaps, other fasteners or connections, or combinations thereof. Additionally, the expandable storage top connector may allow for a plurality of widths to either fully or partially enclose the expandable storage compartment.

The sling bag 100, 200, or 300 may be manufactured using the following steps: cutting fabric like materials to create a front wall, rear wall, a first side wall, a second side wall, a bottom wall, and a removably coupled top of a main storage compartment; cutting fabric like materials to create a front folding section, a first side folding section, a second side folding section, and a bottom folding section of an expandable storage compartment; sewing said sections and walls together to create the main storage compartment and the expandable storage compartment; and coupling the main storage compartment and expandable storage compartment, wherein the first side folding section and the first side wall, the second side folding section and the second side wall, and the bottom section and bottom walls are coupled to one another through a stitching process.

While fishing equipment is referenced herein, the present disclosure could be utilized for other purposes, including, but not limited to, luggage, coolers, and other similar portable storage devices. In certain embodiments, the present disclosure can include a plurality of fishing equipment such as tackle boxes and bait boxes. The fishing equipment may contain a main storage compartment and a plurality of attached storage compartments including an expandable storage compartment. A fastening member, such as at least one zipper, hook and loop fasteners, buttons, snaps, and/or other fasteners may secure each storage compartment while providing easy access to any stored items. The fishing equipment may contain a one handle and/or shoulder strap coupled on or near the main storage compartment. Additionally, any expandable storage compartment may allow at least partial visibility to items stored inside the expandable storage compartment. The expandable storage compartment also may allow a user to access and stow items secured inside the expandable storage compartment with one hand as needed.

In certain examples, the fishing equipment may also have a wall that can unfold to create a relatively level surface while a fisherman carries the equipment. The relatively level surface can have a plurality of uses such as organizing bait to holding an electronic tablet. The foldable wall may allow a user to access the content of at least one storage compartment in an organized fashion along a flat surface. Additionally, the foldable wall may also contract, allowing a user to secure and safely carry items inside a bag.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A storage apparatus comprising:
a main storage compartment, the main storage compartment being defined by a front wall, a rear wall, a first side wall, a second side wall, and a bottom wall;
a removably coupled top coupled to the main storage compartment through a fastener; and
wherein the removably coupled top is restricted in movement by a catch to allow the removably coupled top to be generally ninety-degrees to the main storage compartment.

2. The storage apparatus of claim 1, further comprising a foldable panel, wherein the foldable panel is attached to the front wall.

3. The storage apparatus of claim 2, wherein the foldable panel comprises at least one panel fabric catch, wherein the at least one panel fabric catch is releasably attached to an exterior surface of the front wall, wherein the at least one panel fabric catch is configured to create a tray when the foldable panel is opened.

4. The storage apparatus of claim 3, wherein the at least one panel fabric catch is configured to create a tray at a ninety-degree angle.

5. The storage apparatus of claim 1, wherein the main storage compartment comprises at least one main fabric catch, wherein the at least one main fabric catch is releasably attached to an interior surface of the front wall, wherein the at least one main fabric catch is configured to create a tray when the main storage compartment is opened.

6. The storage apparatus of claim 5, wherein the at least one main fabric catch is configured to create a tray at a ninety-degree angle.

7. A storage system comprising:
a storage apparatus having a main storage compartment, the main storage compartment being defined by a front wall, a rear wall, a first side wall, a second side wall, and a bottom wall, wherein the main storage compartment is configured to hold at least one storage tray;
wherein the at least one storage tray comprises a top portion, a bottom portion, and at least one securing mechanism that can be housed in the main storage compartment of the storage apparatus
a removably coupled top coupled to the main storage compartment through a fastener; and
wherein the removably coupled top is restricted in movement by a catch to allow the removably coupled top to be generally ninety-degrees to the main storage compartment.

8. The storage system of claim 7, further comprising a storage compartment attached to the removably coupled top, wherein the storage compartment is enclosed by a foldable panel.

9. The storage system of claim 8, wherein the foldable panel is restricted in movement by a panel fabric catch to allow the foldable panel to be generally ninety-degrees to the storage compartment.

10. The storage system of claim 9, wherein the storage compartment is configured to secure pouches via a fastener.

11. A method of manufacturing a storage bag, comprising the steps of:
cutting fabric like materials to create a front wall, rear wall, a first side wall, a second side wall, a bottom wall, and a removably coupled top of a main storage compartment;
cutting fabric like materials to create a front folding section, a first side folding section, a second side folding section, and a bottom folding section of an expandable storage compartment;
sewing said sections and walls together to create the main storage compartment and the expandable storage compartment; and
coupling the main storage compartment and expandable storage compartment, wherein the first side folding section and the first side wall, the second side folding section and the second side wall, and the bottom section and bottom walls are coupled to one another through a stitching process.

12. The method of claim 11, further comprising the step of cutting fabric like materials to create at least one main fabric catch, wherein the at least one main fabric catch is configured to couple the removably coupled top to the first side wall and the second side wall.

13. The method of claim 11, further comprising the step of cutting fabric like materials to create at least one panel fabric catch, wherein the at least one panel fabric catch is configured to couple the front folding section to the first side section and the second side section.
